(19) United States
(12) Patent Application Publication
(10) Pub. No.: US 2022/0149358 A1
(43) Pub. Date: May 12, 2022

(54) Negative Electrode Active Material Including Core-Shell Composite and Method of Preparing the Same

(71) Applicant: SK Innovation Co., Ltd., Seoul (KR)

(72) Inventors: Joon Hyung Moon, Daejeon (KR); Gwi Ok Park, Daejeon (KR); Eun Jun Park, Daejeon (KR); Joon Sup Kim, Daejeon (KR); Seok Keun Yoo, Daejeon (KR); Ju Ho Chung, Daejeon (KR)

(21) Appl. No.: 17/524,430

(22) Filed: Nov. 11, 2021

(30) Foreign Application Priority Data
Nov. 12, 2020 (KR) 10-2020-0150866

(51) Int. Cl. H01M 4/36; H01M 4/58; H01M 4/587; H01M 4/04

(52) U.S. Cl. CPC H01M 4/366; H01M 4/5825; H01M 2004/027; H01M 4/0471; H01M 4/587

(57) ABSTRACT

Provided is a negative electrode active material for a lithium secondary battery including a core-shell composite including: a core including a silicon oxide (SiOₓ, 0<x≤2) containing a lithium compound and a graphitic material; and a shell including amorphous carbon, positioned on the core. The silicon oxide (SiOₓ, 0<x≤2) includes at least one lithium silicate selected from Li₂SiO₃, Li₂Si₂O₅, and Li₄SiO₄ in at least a part of the silicon oxide.

### CROSS-REFERENCE TO RELATED APPLICATION

This application claims priority to Korean Patent Application No. 10-2020-0150866 filed Nov. 12, 2020, the disclosure of which is hereby incorporated by reference in its entirety.

### BACKGROUND OF THE INVENTION

### Field of the Invention

The following disclosure relates to a negative electrode active material for a lithium secondary battery including a core-shell composite, a method of preparing the same, a negative electrode including the same, and a lithium secondary battery.

### Description of Related Art

As an issue of global warming which is a problem in modern society arises, a demand for environmentally friendly technologies is rapidly increasing in response thereto. In particular, as a technical demand for electric vehicles and energy storage systems (ESS) increases, a demand for a lithium secondary battery in the spotlight as an energy storage device is exploding. Therefore, studies to improve energy density of the lithium secondary battery are in progress.

However, conventional commercialized secondary batteries commonly use a graphite active material such as natural graphite and artificial graphite, but has a low energy density due to the low theoretical capacity of the graphite, and thus, studies to improve the energy density by developing a new negative electrode material are in progress.

As a solution thereto, a Si-based material having a high theoretical capacity (3580 mAh/g) is emerging as one solution. However, the Si-based material as such has a disadvantage of deteriorated battery life characteristics due to large volume expansion (˜400%) in the course of repeated charge and discharge. Thus, as a method of solving the issue of large volume expansion of the Si material, a SiOₓ material which has a low volume expansion rate as compared with Si has been developed. Though SiOₓ material shows excellent life characteristics due to the low volume expansion rate, it is difficult to apply the SiOₓ material to a lithium secondary battery in practice due to the unique low initial coulombic efficiency (ICE) by initial formation of an irreversible phase.

### SUMMARY OF THE INVENTION

An embodiment of the present invention is directed to providing a negative electrode active material for both improving an initial efficiency and a capacity and improving life characteristics.

Another embodiment of the present invention is directed to providing a negative electrode active material for improving slurry stability and life characteristics, by preventing elution of a lithium compound remaining on a surface of prelithiated silicon-based oxide particles to suppress a side reaction with an electrolyte produced in raising a slurry pH and in a charge and discharge process.

In one general aspect, a negative electrode active material for a lithium secondary battery includes a core-shell composite including: a core including a silicon oxide (SiOₓ, 0<x≤2) containing a lithium compound and a graphitic material; and a shell including amorphous carbon, positioned on the core, wherein the silicon oxide (SiOₓ, 0<x≤2) includes at least one lithium silicate selected from Li₂SiO₃, Li₂Si₂O₅, and Li₄SiO₄ in at least a part of the silicon oxide.

The lithium compound may be at least one or more selected from LiOH, Li, LiH, Li₂O, and Li₂CO₃.

The silicon oxide containing a lithium compound may have a maximum peak position at 460 cm⁻¹ to 500 cm⁻¹ in a Raman spectrum.

The silicon oxide containing a lithium compound may have a maximum peak position at 500 cm⁻¹ to 530 cm⁻¹ in a Raman spectrum.

The core may further include amorphous carbon.

The graphitic material may be natural graphite, artificial graphite, or a combination thereof.

The silicon oxide may be included at 5 to 50 parts by weight, with respect to 100 parts by weight of the core-shell composite.

The graphitic material may be included at 30 to 80 parts by weight, with respect to 100 parts by weight of the core-shell composite.

The shell may have an average thickness of 0.1 to 100 nm.

The composite may be included at 50 parts by weight or more, with respect to 100 parts by weight of the negative electrode active material.

In another general aspect, a method of preparing a negative electrode active material for a lithium secondary battery includes: a) preparing a silicon oxide (SiOₓ, 0<x≤2) containing a lithium compound; b) compounding the silicon oxide containing a lithium compound, a graphitic material, and a carbon precursor to prepare a core-shell composite precursor; and c) heat-treating the core-shell composite precursor to prepare a core-shell composite, wherein the compounding in step b) includes a dry mixing step with a shear stress and a centrifugal force applied, the carbon precursor is introduced in the middle of the dry mixing step, and the silicon oxide (SiOₓ, 0<x≤2) includes at least one lithium silicate selected from Li₂SiO₃, Li₂Si₂O₅, and Li₄SiO₄ in at least a part of the silicon oxide particles.

The compounding in step b) may be performed by a mechanochemical treatment.

Step c) may be performed under an inert atmosphere.

Step a) may be mixing and heat-treating a silicon compound and a lithium precursor.

The lithium compound may be at least one or more selected from LiOH, Li, LiH, Li₂O, and Li₂CO₃.

In another general aspect, a negative electrode for a lithium secondary battery includes the negative electrode active material.

In still another general aspect, a lithium secondary battery includes the negative electrode according to an exemplary embodiment of the present invention; a positive electrode, a separator disposed between the negative electrode and the positive electrode; and an electrolyte solution.

Other features and aspects will be apparent from the following detailed description, the drawings, and the claims.

### BRIEF DESCRIPTION OF THE DRAWING

FIG. 1 is cross-sectional schematic diagrams of a core-shell composite according to an exemplary embodiment of the present invention.

### DETAILED DESCRIPTION OF MAIN ELEMENTS

10: core-shell composite
13: core
15: shell
100: silicon oxide containing lithium compound
200: graphitic material
300: amorphous carbon (core)
400: amorphous carbon (shell)

### DESCRIPTION OF THE INVENTION

Advantages and features of the present invention and methods to achieve them will be elucidated from exemplary embodiments described below in detail with reference to the accompanying drawings. However, the present invention is not limited to exemplary embodiments disclosed below, but will be implemented in various forms. The exemplary embodiments of the present invention make disclosure of the present invention thorough and are provided so that those skilled in the art can easily understand the scope of the present invention. Therefore, the present invention will be defined by the scope of the appended claims. Detailed description for carrying out the present invention will be provided with reference to the accompanying drawings below. Regardless of the drawings, the same reference number indicates the same constitutional element, and “and/or” includes each of and all combinations of one or more of mentioned items.

Unless otherwise defined herein, all terms used in the specification (including technical and scientific terms) may have the meaning that is commonly understood by those skilled in the art. Throughout the present specification, unless explicitly described to the contrary, “comprising” any elements will be understood to imply further inclusion of other elements rather than the exclusion of any other elements. In addition, unless explicitly described to the contrary, a singular form includes a plural form herein.

In the present specification, it will be understood that when an element such as a layer, film, region, or substrate is referred to as being “on” or “above” another element, it can be directly on the other element or intervening elements may also be present.

In the present specification, an average particle size may refer to D50, and D50 refers to a diameter of a particle with a cumulative volume of 50% when cumulated from the smallest particle in measurement of a particle size distribution by a laser scattering method. Here, for D50, the particle size distribution may be measured by collecting a sample according to a KS A ISO 13320-1 standard and using Mastersizer 3000 available from Malvern Panalytical Ltd. Specifically, a volume density may be measured after particles are dispersed in ethanol as a solvent, if necessary, using an ultrasonic disperser.

The present invention provides a negative electrode active material for a lithium secondary battery including a core-shell composite including: a core including a silicon oxide (SiOₓ, 0<x≤2) containing a lithium compound and a graphitic material; and a shell including amorphous carbon, positioned on the core, wherein the silicon oxide (SiOₓ, 0<x≤2) includes at least one lithium silicate selected from Li₂SiO₃, Li₂Si₂O₅, and Li₄SiO₄ in at least a part of the silicon oxide.

The core includes a silicon oxide (SiOₓ, 0<x≤2) containing a lithium compound and a graphitic material.

The lithium oxide includes a lithium compound, and as an example, the lithium compound may include at least one or more selected from LiOH, Li, LiH, Li₂O, and Li₂CO₃. The lithium compound remains on a surface of a prelithiated silicon compound and is residual lithium remaining unreacted after prelithiation, which is a material essentially occurring in a prelithiation process of a silicon-based compound.

As described above, the lithium compound may be present on the surface of the silicon oxide, may be eluted in the preparation of the core-shell composite to be present in the core, and may be present on the surface of the silicon oxide and/or on the surface of the graphitic material.

The lithium compound may increase a pH of a negative electrode slurry when being dissolved in a solvent (e.g., water) in a preparation process of the negative electrode slurry including the negative electrode active material, and the increase in the pH contracts a chain of a polymer binder which is an essential component of the slurry, thereby causing problems such as a decrease in an adhesive strength between current collector-negative electrode active material due to a decreased viscosity of the slurry and gas production due to oxidation of a Si component of the silicon-based active material. The results may cause not only a decrease in stability of the negative electrode active material, but also a decrease in capacity.

In the present invention, since the core-shell composite is prepared under specific conditions, the elution of the lithium compound (residual lithium) may be effectively suppressed, thereby solving the problems described above. In addition, since the prelithiated silicon oxide is included inside the core, a problem of low initial efficiency may be improved, and as a result, it is possible to improve a battery capacity and life characteristics.

The silicon oxide may have a maximum peak position at 500 cm⁻¹ to 530 cm⁻¹, for example, in a range of more than 500 cm⁻¹ and less than 530 cm⁻¹, 505 cm⁻¹ or more and less than 530 cm⁻¹, or 510 cm⁻¹ or more and less than 530 cm⁻¹, in a Raman spectrum.

It is preferred that the silicon oxide may have a maximum peak position at 460 cm⁻¹ to 500 cm⁻¹, for example, in a range of more than 460 cm⁻¹ and less than 500 cm⁻¹, more than 460 cm⁻¹ and 490 cm⁻¹ or less, or more than 460 cm⁻¹ and 480 cm⁻¹ or less, in a Raman spectrum.

As the maximum peak position of the silicon oxide in a Raman spectrum is increased in a range of 500 to 530 cm⁻¹, growth of crystalline Si (hereinafter, referred to as c-Si) in the silicon oxide is promoted as compared with non-crystalline Si (hereinafter, referred to as a-Si) to increase a ratio of c-Si/a-Si. In terms of minimizing a volume change based on intercalation and deintercalation of a lithium ion due to a high content of C—Si, the maximum peak position may be at 460 cm⁻¹ to 500 cm⁻¹, preferably at 460 cm⁻¹ to 480 cm⁻¹. Within the range, a content of a-Si, that is, Si in a non-crystalline state is increased to suppress volume expansion occurring in a charge and discharge process, and furthermore, deterioration of the negative electrode active material, and thus, battery characteristics may be improved.

Meanwhile, being crystalline means that the shape of single Si positioned inside the particle is crystalline, and being amorphous means that the shape of single Si positioned inside the particle is amorphous or the particles are so fine that it is difficult to measure the particle size by Scherrer's equation among XRD analysis methods.

In addition, the silicon oxide (SiOₓ, 0<x≤2) includes at least one lithium silicate selected from Li₂SiO₃, Li₂Si₂O₅, and Li₄SiO₄ in at least a part of the silicon oxide,

When forming a Li₂SiO₃ phase, a smaller amount of Si is consumed than the amount of Si consumed in forming a phase of lithium silicate such as Li₂Si₂O₅, and thus, capacity characteristics may be improved and a severe volume change of Si during a battery cycle life is mitigated, which is advantageous for improvement of life characteristics. Meanwhile, a Li₄SiO₄ phase is not preferred, since it has a high reactivity with moisture and it is difficult to adjust the physical properties of a slurry in manufacture of an electrode.

The silicon oxide may include 10 to 100 parts by weight, preferably 30 to 90 parts by weight, and more preferably 50 to 90 parts by weight, with respect to 100 of the silicon oxide. Within the range of content, formation of an initial irreversible phase of the silicon oxide occurring in initial charge and discharge may be suppressed to increase an initial efficiency and a capacity.

Meanwhile, the silicon oxide may include 25 parts by weight or less, preferably 10 parts by weight or less, more preferably 5 parts by weight or less, and still more preferably less than 1 part by weight of Li₄SiO₄, with respect to 100 parts by weight of the silicon oxide. The Li₄SiO₄ phase has irreversible characteristics to a Li ion and is vulnerable to moisture, and thus, is not preferred as an active material of a negative electrode using a water-based binder. Within the range of Li₄SiO₄ phase, water resistance of a negative electrode slurry may be improved.

Here, the silicon oxide may have an average particle size of 2 to 30 μm, preferably 5 to 10 μm.

The graphitic material is for intercalating/deintercalating a lithium ion to increase conductivity, and is partially or entirely formed of graphite or may be obtained by subjecting the graphitic material to various chemical treatments in liquid, gaseous, or solid phases, a heat treatment, an oxidation treatment, a physical treatment, and the like. A specific example thereof includes graphite such as amorphous, plate-like, flake-like, spherical, or fibrous natural graphite and/or artificial graphite, but the graphitic material may be natural graphite, in terms of low resistance and economic feasibility.

The graphitic material may have an average particle size of 1 to 50 μm, preferably 3 to 15 μm, and within the range, a difference in an expansion rate between the graphitic material and the silicon oxide in the core may be decreased to suppress interfacial separation. The core may further include amorphous carbon. An example of the amorphous carbon includes soft carbon or hard carbon, a mesophase pitch carbide, calcined coke, and the like. The amorphous carbon acts as a buffer to relieve expansion in an interface between the graphitic material and silicon oxide particles inside the core, thereby decreasing problems of decreased capacity and life characteristics due to the volume expansion.

The shell positioned on the core includes amorphous carbon, and specifically, the amorphous carbon may be the same material as the amorphous carbon included in the core described above. Here, the shell may have an average thickness of 0.1 to 100 nm, preferably 1 to 10 nm, and more preferably 2 to 5 nm. Within the thickness range, elution of the lithium compound included in the core into a slurry and an electrolyte may be effectively prevented to improve life characteristics.

Specifically, the shell may be formed so that the lithium compound and the silicon oxide in the core are not eluted to the surface of the core-shell composite. Preferably, the shell may be formed so that the lithium compound, the silicon oxide, and the graphitic material in the core are not eluted to the surface of the core-shell composite. More preferably, the amorphous carbon is uniformly applied on the core to form a layer.

That is, the shell of the present invention includes the amorphous carbon, and may not include the lithium compound, the silicon oxide containing a lithium compound, the graphitic material, or a combination thereof included in the core.

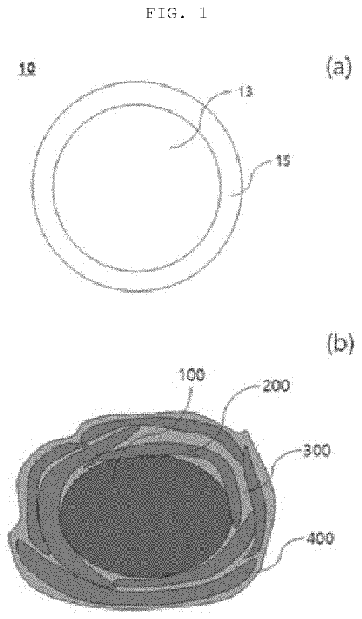

FIG. 1 is cross-sectional schematic diagrams of a core-shell composite according to an exemplary embodiment of the present invention. Referring to FIG. 1, the core-shell composite 10 may have a structure in which a core 13 includes a silicon oxide containing a lithium compound 100, a graphitic material 200, and amorphous carbon 300 inside and a shell 15 surrounding the core includes amorphous carbon 400. Since the amorphous carbon is included in both the inside of the core and the shell, an electrical conduction path is supplied to the inside of the core to show an excellent electrical conductivity and the elution of the lithium compound into the inside of the core may be effectively prevented.

The core-shell composite may include 5 to 50 parts by weight, preferably 10 to 50 parts by weight, and more preferably 20 to 40 parts by weight of the silicon oxide, with respect to 100 parts by weight of the core-shell composite.

The core-shell composite may include 30 to 80 parts by weight, preferably 40 to 80 parts by weight, and more preferably 50 to 80 parts by weight of the graphitic material, with respect to 100 parts by weight of the core-shell composite.

The core-shell composite may include 5 to 25 parts by weight, preferably 5 to 15 parts by weight, and more preferably 7 to 12 parts by weight of the amorphous carbon, with respect to 100 of the core-shell composite. Within the range, the amorphous carbon may form a uniformly distributed shell and penetrate inside the core to increase an electrical conductivity according to an electrical conduction path supply.

A content of lithium in the core-shell composite may be 1.3 wt % or more, 1.3 to 5 wt %, 1.3 to 4 wt %, 2 to 5 wt %, 2.5 to 5 wt %, 2.5 to 4 wt %, 2.5 to 3.5 wt %, or 3 to 3.5 wt %. Here, the content of lithium may refer to a total weight of a lithium element present in the core-shell composite, specifically a total weight of residual lithium which is not eluted in the slurry and a lithium element included in a lithium silicate. Meanwhile, the residual lithium is decreased with an increase of a content of the lithium compound dissolved in a solvent, that is, an elution amount of the lithium compound in a process of preparing a negative electrode slurry. Therefore, under the same lithium silicate content condition, a higher content of residual lithium is advantageous in terms of suppressing elution of the lithium compound, but in terms of an initial charge and discharge capacity and capacity decrease suppression, it is advantageous that the content of lithium in the core-shell composite satisfies the range.

More specifically, the core-shell composite may have a ratio (A/B) of a lithium content (A, wt %) in the core-shell composite relative to a lithium silicate content (B, wt %) in the silicon-based oxide of 0.020 or more, 0.020 to 0.050, preferably 0.033 to 0.043. Within the range, the content of residual lithium in the core-shell composite may be maximized to prevent a pH increase of a negative electrode slurry due to the elution of the lithium compound inside the core. Meanwhile, when the pH of the slurry is increased, a chain of a carboxymethyl cellulose polymer in a binder, which is an essential composition of the slurry, is condensed to lower the viscosity of the slurry and decrease adhesive strength in electrode coating.

Meanwhile, the content of lithium in the core-shell composite may be measured by inductively coupled plasma spectrometer (ICP) analysis, and the content of lithium silicate may be measured by X-ray diffraction (XRD) analysis, but the present invention is not limited thereto.

The core-shell composite may be included at 50 parts by weight or more, preferably 60 parts by weight or 70 parts by weight or more, more preferably 80 parts by weight or 90 parts by weight or more, and as an example, 100 parts by weight, with respect to 100 parts by weight of the negative electrode active material. Conventionally, excellent life characteristics were not implemented due to volume expansion of an electrode to which a silicon oxide is applied, and thus, a graphitic active material or the like which may relieve contraction/expansion of silicon oxide-based particles was mixed more than a half or amorphous carbon was used at an excessive amount in the core-shell composite including a silicon-based material. Since the present invention may suppress production of crystalline c-Si in prelithiation of the silicon oxide particles and increase a ratio of a-Si, a negative electrode active material using the core-shell composite including a silicon oxide containing Li₂SiO₃ at a high content may be provided. Thus, initial efficiency and life characteristics may be improved as compared with the conventional technology and, simultaneously, a discharge capacity may be further improved.

The present invention also provides a method of preparing a negative electrode active material for a lithium secondary battery, including: a) preparing a silicon oxide (SiOₓ, 0<x≤2) containing a lithium compound; b) compounding the silicon oxide containing a lithium compound, a graphitic material, and a carbon precursor to prepare a core-shell composite precursor; and c) heat-treating the core-shell composite precursor to prepare a core-shell composite, wherein the compounding is performed by dry mixing with a shear stress and a centrifugal force applied, the carbon precursor is introduced in the middle of the dry mixing step, and the silicon oxide (SiOₓ, 0<x≤2) includes at least one lithium silicate selected from Li₂SiO₃, Li₂Si₂O₅, and Li₄SiO₄ in at least a part of the silicon oxide particles.

Step a) is a step of preparing a silicon oxide and may be divided into a first step of preparing a silicon compound and a second step of prelithiating the silicon compound to prepare a silicon oxide containing a lithium compound.

In the first step, preparation may be performed by mixing Si powder and SiO₂ powder by appropriately adjusting a mixing ratio thereof so that mole ratios of Si and O of the silicon compound particles (SiOₓ, 0<x≤2) prepared are formed, and then performing a heat treatment at a temperature of lower than 900° C., preferably lower than 800° C., or a temperature of 500 to 700° C., and more preferably 500 to 650° C. for 1 to 12 hours or 1 to 8 hours under an inert atmosphere and under reduced pressure. Conventionally, in order to prepare the silicon compound particles, the heat treatment was performed at a high temperature of 900 to 1600° C., but in the case of a SiOₓ material or a SiO material, a c-Si seed grows at a heat treatment temperature of 800° C. or higher and a crystallite grows clearly at about 900° C., and thus, in the present invention, preparation is performed by the heat treatment at a temperature of 500 to 650° C., for suppressing formation of a c-Si seed and growth of c-Si to prepare an amorphous or microcrystalline silicon compound. The silicon compound prepared may be pulverized to prepare silicon compound particles.

The second step is a step of prelithiating the silicon compound particles prepared, and mixing and a heat treatment with a lithium precursor may be performed to prepare a negative electrode active material including at least one lithium silicate selected from Li₂SiO₃, Li₂Si₂O₅, and Li₄SiO₄ in at least a part of the silicon oxide.

Specifically, the silicon compound and the lithium precursor may be mixed so that a Li/Si mole ratio is 0.3 to 1.0, preferably 0.3 to 0.8, and more preferably 0.4 to 0.8. Within the mixing range, an optimal ratio of Li₂SiO₃ and Li₂Si₂O₅ may be obtained, and formation of c-Si and Li₄SiO₄ may be suppressed to greatly improve electrochemical performance of a battery.

As the lithium precursor, at least one or more selected from LiOH, Li, LiH, Li₂O, and Li₂CO₃ may be used, and the compound is not particularly limited as long as it may be decomposed during the heat treatment.

Subsequently, the compound may be heat-treated at 500° C. to 700° C. for 1 to 12 hours under an inert atmosphere. When the heat treatment is performed at a temperature of 700° C. or higher, a disproportionation reaction occurs or growth of a Si crystal is accelerated, so that the growth of c-Si is inevitable, and when a raw material is prepared at a temperature of lower than 700° C., crystal growth is suppressed to make it possible to prepare amorphous or microcrystalline silicon oxide particles. In addition, when the heat treatment is performed at a low temperature of lower than 500° C., prelithiation is not sufficiently performed. Meanwhile, in the prelithiation by an electrochemical method or an oxidation-reduction method, Li₄SiO₄ is likely to be produced as a lithium silicate, but according to the present invention, a target lithium silicate having a different composition may be synthesized in a high purity by the heat treatment. Here, the inert gas may be selected from Ne, Ar, Kr, N₂, and the like, and preferably Ar or N₂ may be used, but the present invention is not limited thereto.

The lithium oxide prepared by step a) may include at least one or more lithium compounds selected from LiOH, Li, LiH, Li₂O, and Li₂CO₃.

Step b) is a step of preparing a core-shell composite precursor, and the compounding of the silicon oxide containing a lithium compound prepared in step a), a graphitic material, and a carbon precursor may be performed by a solid phase reaction, without a use of a solvent. Specifically, the compounding may be performed by dry mixing of with a shear stress and a centrifugal force applied, and preferably, may be performed by a mechanochemical treatment.

The mechanochemical process is a process for preparing composite particles by applying a compression and a shear force to two or more kinds of particles different from each other to be closely adhered to each other, and Mechanofusion system powder compounding equipment available from Hosokawa Micron Ltd. may be used. It is preferred that a circumferential speed difference between a rotating drum and an inner member is 10 to 50 m/s, a distance therebetween is 1 to 100 mm, and a treatment time is 30 to 120 minutes. Since the mechanochemical treatment is performed under the above conditions, a density of amorphous carbon on a surface of silicon oxide particles is increased after step c) to form a smooth coating layer (shell), and thus, elution of a lithium compound (residual lithium) may be effectively suppressed. However, a simple mixing method such as a ball mill or spray is an irregular mixing method, and it is difficult to secure a uniform and smooth coating layer with the method.

In step b), a carbon precursor may be introduced in the middle of the dry mixing, specifically the mechanochemical process. Herein, the middle of the step may refer to a point of 10 to 90%, preferably 30 to 90%, and more preferably 40 to 90% with respect to 100% of cumulative time. Within the range, the carbon precursor is introduced and the mechanochemical treatment is further performed, thereby obtaining a core having a composite structure in which the graphitic material is adhered on the silicon oxide containing a lithium compound and a core-shell composite having a structure in which a carbon-based precursor is uniformly distributed in both the inside of the core and the shell. Accordingly, expansion in the interface of the graphitic material inside the core and the silicon oxide particles may be relieved to suppress deterioration of a capacity, and elution of the lithium compound included in the core by shell into a slurry and an electrolyte may be effectively prevented to improve life characteristics.

Step c) is a step of preparing a core-shell composite, which may be obtained by heat-treating the core-shell composite precursor. The heat treatment process may be performed at a temperature of 400 to 800° C., and more preferably at a temperature of 550 to 700° C. Within the heat treatment temperature range, the carbon precursor may be sufficiently carbonized to improve a conductivity, and a content of Si in a non-crystalline state in the silicon oxide may be increased to suppress deterioration of the negative electrode active material and improve the characteristics of a battery including the same. Here, the heat treatment may be performed under an inert atmosphere, specifically under an atmosphere selected from Ne, Ar, Kr, N₂, and the like, and preferably using Ar or N₂, but is not limited thereto.

The present invention also provides a negative electrode for a lithium secondary battery including the negative electrode active material according to an exemplary embodiment of the present invention. Specifically, the negative electrode includes: a current collector; and a negative electrode active material layer including the negative electrode active material and a water-based binder, disposed on the current collector.

The current collector may be selected from the group consisting of a copper foil, a nickel foil, a stainless steel foil, a titanium foil, a nickel foam, a copper foam, a polymer substrate coated with a conductive metal, and a combination thereof, but is not limited thereto.

The negative electrode active material layer includes the negative electrode active material and the water-based binder, and optionally, may further include a conductive material.

The negative electrode active material includes a core-shell composite including: a core including a silicon oxide (SiOₓ, 0<x≤2) containing a lithium compound and a graphitic material; and a shell including amorphous carbon, positioned on the core, and may further optionally include a material capable of reversibly intercalating/deintercalating a lithium ion, a lithium metal, an alloy of a lithium metal, a material capable of doping and dedoping into lithium, or a transition metal oxide. Herein, the silicon oxide (SiOₓ, 0<x≤2) includes at least one lithium silicate selected from Li₂SiO₃, Li₂Si₂O₅, and Li₄SiO₄ in at least a part of the silicon oxide.

Examples of the material which may reversibly intercalate/deintercalate the lithium ion include a carbon material, that is, a carbon-based negative electrode active material which is commonly used in the lithium secondary battery. Representative examples of the carbon-based negative electrode active material include crystalline carbon, amorphous carbon, or a combination thereof. Examples of the crystalline carbon include graphite such as amorphous, plate-shaped, flake-shaped, spherical, or fibrous natural graphite or artificial graphite, and examples of the amorphous carbon include soft carbon or hard carbon, a mesophase pitch carbide, calcined coke, and the like.

The alloy of the lithium metal may be an alloy of lithium with a metal selected from the group consisting of Na, K, Rb, Cs, Fr, Be, Mg, Ca, Sr, Si, Sb, Pb, In, Zn, Ba, Ra, Ge, Al, and Sn.

The material which may be doped and dedoped with lithium may be a silicon-based material, for example, Si, SiOₓ (0<x<2), a Si-Q alloy (Q is an element selected from the group consisting of alkali metals, alkali earth metals, Group 13 elements, Group elements, Group 15 elements, Group 16 elements, transition metals, rare-earth elements, and combinations thereof, and is not Si), a Si-carbon composite, Sn, SnO₂, a Sn—R alloy (R is an element selected from the group consisting of alkali metals, alkali earth metals, Group 13 elements, Group 14 elements, Group elements, Group 16 elements, transition metals, rare-earth elements, and combinations thereof, and is not Si), a Sn-carbon composite, and the like, and also, a mixture of at least one thereof and SiO₂ may be used. The elements Q and R may be selected from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ge, P, As, Sb, Bi, S, Se, Te, Po, and a combination thereof.

The transition metal oxide may be a lithium titanium oxide.

The water-based binder serves to adhere negative electrode active material particles to each other and to attach the negative electrode active material to the current collector well. The water-based binder may be polyvinylidene fluoride (PVDF), polyvinyl alcohol, carboxymethyl cellulose (CMC), starch, hydroxypropyl cellulose, regenerated cellulose, polyvinylpyrrolidone, tetrafluoroethylene, polyethylene, polypropylene, ethylene-propylene-diene monomer (EPDM), sulfonated-EPDM, styrene-butadiene rubber (SBR), fluorine rubber, various copolymers thereof, and the like, and specifically, the binder may include a binder formed of carboxymethyl cellulose (CMC), styrene-butadiene rubber (SBR), and a mixture thereof.

The conductive material is used for imparting conductivity to an electrode and any conductive material may be used as long as it is an electroconductive material without causing a chemical change in the battery to be configured. Examples of the conductive material include carbon-based materials such as natural graphite, artificial graphite, carbon black, acetylene black, ketjen black, and carbon fiber; metal-based materials such as metal powder or metal fiber of copper, nickel, aluminum, silver, and the like; conductive polymers such as a polyphenylene derivative; or a mixture thereof.

Each of the contents of the binder and the conductive material in the negative electrode active material layer may be 1 to 10 wt %, preferably 1 to 5 wt % with respect to the total weight of the negative electrode active material layer, but is not limited thereto.

The present invention also provides a lithium secondary battery including: the negative electrode; a positive electrode; a separator disposed between the negative electrode and the positive electrode; and an electrolyte solution.

The negative electrode is as described above.

The positive electrode includes a positive electrode active material layer formed by applying a positive electrode slurry including a positive electrode active material on the current collector.

The current collector may be a negative electrode current collector described above, and any known material in the art may be used, but the present invention is not limited thereto.

The positive electrode active material layer includes the positive electrode active material, and optionally, may further include a binder and a conductive material. The positive electrode active material may be any known positive electrode active material in the art, and for example, it is preferred to use a composite oxide of lithium with a metal selected from cobalt, manganese, nickel, and a combination thereof, but the present invention is not limited thereto.

The binder and the conductive material may be a binder and a negative electrode conductive material described above, and any known material in the art may be used, but the present invention is not limited thereto.

The separator may be selected from glass fiber, polyester, polyethylene, polypropylene, polytetrafluoroethylene, or a combination thereof, and may be in the form of nonwoven or woven fabric. For example, a polyolefin-based polymer separator such as polyethylene or polypropylene may be mainly used in the lithium secondary battery, a separator coated with a composition including a ceramic component or a polymer material for securing thermal resistance or mechanical strength, optionally, a single layer or a multilayer structure may be used, and any known separator in the art may be used, but the present invention is not limited thereto.

The electrolyte solution includes an organic solvent and a lithium salt.

The organic solvent serves as a medium in which ions involved in the electrochemical reaction of the battery may move, and for example, carbonate-based, ester-based, ether-based, ketone-based, alcohol-based, or aprotic solvents may be used, the organic solvent may be used alone or in combination of two or more, and when used in combination of two or more, a mixing ratio may be appropriately adjusted depending on battery performance to be desired. Meanwhile, any known organic solvent in the art may be used, but the present invention is not limited thereto.

The lithium salt is dissolved in the organic solvent and acts as a source of the lithium ion in the battery to allow basic operation of the lithium secondary battery and is a material which promotes movement of lithium ions between a positive electrode and a negative electrode. Examples of the lithium salt include LiPF₆, LiBF₄, LiSbF₆, LiAsF₆, LiN(SO₃C₂F₅)₂, LiN(CF₃SO₂)₂, LiC₄F₉SO₃, LiClO₄, LiAlO₂, LiAlCl₄, LiN(CₓF₂ₓ₊₁SO₂)(C_{y}F_{2y+1}SO₂) (x and y are natural numbers), LiCl, LiI, LiB(C₂O₄)₂, or a combination thereof, but the present invention is not limited thereto.

A concentration of the lithium salt may be in a range of 0.1 M to 2.0 M. When the lithium salt concentration is within the range, the electrolyte solution has appropriate conductivity and viscosity, and thus, may exhibit excellent electrolyte solution performance and lithium ions may effectively move.

In addition, the electrolyte solution may further include pyridine, triethylphosphate, triethanolamine, cyclic ether, ethylene diamine, n-glyme, hexaphosphate triamide, a nitrobenzene derivative, sulfur, a quinone imine dye, N-substituted oxazolidinone, N,N-substituted imidazolidine, ethylene glycol dialkyl ether, an ammonium salt, pyrrole, 2-methoxyethanol, aluminum trichloride, and the like, if necessary, for improving charge/discharge characteristics, flame retardant characteristics, and the like. In some cases, a halogen-containing solvent such as carbon tetrachloride and ethylene trifluoride may be further included for imparting non-flammability, and fluoro-ethylene carbonate (FEC), propene sultone (PRS), fluoro-propylene carbonate (FPC), and the like may be further included for improving conservation properties at a high temperature.

The method of manufacturing a lithium secondary battery according to the present invention for achieving the above object may include laminating the negative electrode prepared, separator, and positive electrode in this order to form an electrode assembly, placing the produced electrode assembly in a cylindrical battery case or an angled battery case, and then injecting an electrolyte solution. Otherwise, the lithium secondary battery may be manufactured by laminating the electrode assembly and immersing the assembly in the electrolyte solution to obtain a resultant product which is then placed in a battery case and sealed.

As the battery case used in the present invention, those commonly used in the art may be adopted, there is no limitation in appearance depending on the battery use, and for example, a cylindrical shape, an angled shape, a pouch shape, a coin shape, or the like using a can may be used.

The lithium secondary battery according to the present invention may be used in a battery cell used as a power supply of a small device, and also may be preferably used as a unit cell in a medium or large battery module including a plurality of battery cells. Preferred examples of the medium or large device include an electric automobile, a hybrid electric automobile, a plug-in hybrid electric automobile, a system for power storage, and the like, but are not limited thereto.

Hereinafter, the preferred Examples and Comparative Examples of the present invention will be described. However, the following Examples are only a preferred exemplary embodiment of the present invention, and the present invention is not limited thereto.

### EXAMPLES

### Example 1

Step 1: Preparation of Silicon Compound

A raw material in which a silicon metal and silicon dioxide were mixed was introduced to a reaction furnace and evaporated at 600° C. for 5 hours in the atmosphere having a vacuum degree of 10 Pa, and the resulting product was deposited on a suction plate and sufficiently cooled and then a deposit was taken out and pulverized with a ball mill. Thus, silicon compound particles of SiO were obtained, wherein x is 1.0. Continuously, a particle diameter of the silicon compound particles was adjusted by sorting to obtain SiO particles having an average particle diameter (D50) of 8 μm.

Step 2: Preparation of Silicon Oxide Containing Lithium Compound

SiO particles and LiOH powder prepared above were mixed so that a mole ratio of Li/Si was 0.75 to form a mixed powder, and the mixed powder and a zirconia ball (1-20 times the mixed powder) were placed in an airtight container and mixed using a shaker for 30 minutes. Thereafter, the mixed powder was filtered using a sieve of 25 to 250 μm and then placed in an alumina crucible.

The aluminum crucible was heat-treated at 550° C. for 8 hours under a nitrogen gas atmosphere. Subsequently, the heat-treated powder was recovered and pulverized in a mortar to prepare a silicon oxide containing a lithium compound. The silicon oxide had an average particle size of 6.7 μm at that time.

Step 3: Preparation of Core-Shell Composite

30 wt % of the silicon oxide prepared above (D50: 6.7 μm) and 60 wt % of scaly natural graphite particles (D50: 12.5 μm) were mechanically dry-mixed, and then subjected to a mechanochemical treatment for 30 minutes using Mechanofusion equipment (Hosokawa Micron Ltd., AMS). A rotation speed of a drum was 20 m/s and a distance with an inner member was 10 mm at that time. Next, 10 wt % of a coal-based pitch binder was added, and a further mechanochemical treatment was performed for 30 minutes.

Thereafter, heating to 600° C. was performed at a rate of 3° C./min under a high-purity argon atmosphere, and a heat treatment at 600° C. was performed for 4 hours to prepare a core-shell composite.

Step 4: Manufacture of Negative Electrode

95 wt % of the core-shell composite prepared, 1.5 wt % of carboxymethyl cellulose, 2 wt % of a styrene-butadiene rubber, and 1.5 wt % of a conductive material Super C were mixed with distilled water to prepare a slurry. A negative electrode was manufactured by a common process of applying the slurry on a Cu foil current collector, and drying and rolling the slurry.

Step 5: (Manufacture of Half Battery)

The negative electrode manufactured above and a lithium metal as a counter electrode were used, a PE separator was interposed between the negative electrode and the counter electrode, and then an electrolyte solution was injected to manufacture a CR2016 coin cell. The assembled coin cell was paused at room temperature for 3 to 24 hours to manufacture a half battery. Here, the electrolyte solution was obtained by mixing 1.0 M LiPF₆ as a lithium salt with an organic solvent (EC:EMC=3:7 vol %) and mixing 2 vol % of FEC 2 as an electrolyte solution additive.

### Evaluation Example

### Evaluation Example 1: Evaluation of Characteristics of Coal-Based Pitch Binder Depending on Introduction Time

### Examples 1 and 2, and Comparative Examples 1 and 2

### Example 2

The process was performed in the same manner as in Example 1, except that in Step 3, 30 wt % of the silicon oxide prepared above (D50: 6.7 μm) and 60 wt % of scaly natural graphite primary particles (D50: 12.5 μm) were mechanically dry-mixed, a mechanochemical treatment was performed for 50 minutes under a condition of a distance with an inner member of 10 mm at a drum rotation speed of 20 m/s using Mechanofusion equipment (Hosokawa Micron Ltd., AMS), 10 wt % of a coal-based pitch binder was added, and a mechanochemical treatment was further performed for 10 minutes.

### Comparative Example 1

The process was performed in the same manner as in Example 1, except that in Step 3, 30 wt % of the silicon oxide prepared above (D50: 6.7 μm) and 10 wt % of a coal-based pitch binder were mechanically dry-mixed, a mechanochemical treatment was performed for 30 minutes under a condition of a distance with an inner member of 10 mm at a drum rotation speed of 20 m/s using Mechanofusion equipment (Hosokawa Micron Ltd., AMS), 60 wt % of scaly natural graphite primary particles (D50: 12.5 μm) were introduced, and the mechanochemical treatment was further performed for 30 minutes.

### Comparative Example 2

The process was performed in the same manner as in Example 1, except that in Step 3, 30 wt % of the silicon oxide prepared above (D50: 6.7 μm), 60 wt % of scaly natural graphite primary particles (D50: 12.5 μm), and 10 wt % of a coal-based pitch binder were mechanically dry-mixed, and then a mechanochemical treatment was performed for 60 minutes under a condition of a distance with an inner member of 10 mm at a drum rotation speed of 20 m/s using Mechanofusion equipment (Hosokawa Micron Ltd., AMS).

(Evaluation Method)

* Evaluation of Interfacial Resistance

For the electrodes manufactured in Examples 1 and 2 and Comparative Examples 1 and 2, an interfacial resistance value of a negative electrode under a condition of a current of 10 mA and a voltage range of 0.5 V, using HIOKI XF057 PROBE UNIT equipment.

The measurement results are shown in the following Table 1.

* Measurement of pH of Slurry Including Core-Shell Composite

The pH of the slurries prepared in Examples 1 and 2 and Comparative Examples 1 and 2 was measured, and the results are shown in the following Table 1.

* Evaluation of Interfacial Adhesive Strength Between Negative Electrode Active Material Layer and Current Collector

The negative electrodes manufactured in Examples 1 and 2 and Comparative Examples 1 and 2 were cut into a size of a width of 18 mm/a length of 150 mm, and a tape having a width of 18 mm was attached on a foil layer of the negative electrode and then sufficiently adhered by a roller having a load of 2 kg. An active material layer of the negative electrode was attached to one side of a tensile tester using a double-sided tape. The tape attached to the foil was fastened to the other side of the tensile tester and the adhesive strength was measured. The measurement results are shown in the following Table 1.

TABLE 1

| | | Time of | Time of | Heat treatment | | Interfacial | Adhesive |
|---|---|---|---|---|---|---|---|
| | | introducing | introducing | temperature | pH of | resistance | stength |
| | Process | graphite | pitch | (° C.) | slurry | (Ohmcm²) | (N) |
| Example 1 | Mechanochemical | Initially | After 30 | 600 | 8.7 | 0.008 | 0.58 |
| | | | minutes | | | | |
| Example 2 | Mechanochemical | Initially | After 50 | 600 | 8.5 | 0.015 | 0.53 |
| | | | minutes | | | | |
| Comparative | Mechanochemical | After 30 | Initially | 600 | 8.6 | 0.022 | 0.53 |
| Example 1 | | minutes | | | | | |
| Comparative | Mechanochemical | Initially | Initially | 600 | 9.6 | 0.016 | 0.34 |
| Example 2 | | | | | | | |

As seen in Table 1, in Examples 1 and 2 in which the coal-based pitch binder was introduced in the middle of a step of a mechanochemical process of the silicon oxide and the natural graphite particles, a low pH of the slurry was shown, and it was confirmed that both resistance and adhesive strength were excellent as compared with the Comparative Examples. It is considered that since the coal-based pitch binder was uniformly applied on the inside of the core and on the shell of the core-shell composite to effectively suppress the elution of the lithium compound into the slurry, a low slurry pH was shown, and since an electron conduction path was sufficiently produced in the silicon oxide inside the core by the coal-based pitch binder, a low resistance was shown. In addition, it is considered that when the pH of the slurry was increased, the chain of the carboxymethyl cellulose polymer was condensed to lower the viscosity of the slurry and decrease the adhesive strength in electron coating, and due to the low pH of the slurry, the adhesive strength was also excellent.

However, in Comparative Example 1 in which the coal-based pitch binder was introduced initially before starting the mechanochemical process, it is considered that the coal-based pitch binder was uniformly applied on the shell of the core-shell composite and the resulting pH of the slurry and adhesive strength were excellent, but since the binder did not sufficiently penetrate inside the core, a resistance was increased due to lack of an electrical conductive path.

In addition, in Comparative Example 2 in which the silicon oxide, the natural graphite particles, and the coal-based pitch binder were mixed together, and then subjected to the mechanochemical treatment, it is considered that inside the core of the core-shell composite, the coal-based pitch binder and the silicon oxide were uniformly compounded, so that a low resistance was shown, but on the shell, sufficient application was not performed, and the silicon oxide containing a lithium compound was brought into direct contact with water in a water-based slurry phase, so that the lithium compound is eluted to increase the pH of the slurry. It is considered that the increased pH of the slurry decreased the viscosity of the slurry, thereby significantly decreasing the adhesive strength in electrode coating so that the adhesive strength was significantly decreased.

### Evaluation Example 2: Evaluation of Characteristics Depending on Compounding Process

### Comparative Examples 2 to 5

### Comparative Example 3

The process was performed in the same manner as in Example 1, except that in Step 3, 30 wt % of the silicon oxide prepared above (D50: 6.7 μm) and 70 wt % of scaly natural graphite primary particles (D50: 12.5 μm) were mechanically dry-mixed, and then a mechanochemical treatment was performed for 60 minutes under a condition of a distance with an inner member of 10 mm at a drum rotation speed of 20 m/s using Mechanofusion equipment (Hosokawa Micron Ltd., AMS).

### Comparative Example 4

The process was performed in the same manner as in Example 1, except that in Step 3, 30 wt % of the silicon oxide prepared above (D50: 6.7 μm), 60 wt % of scaly natural graphite primary particles (D50: 12.5 μm), and 10 wt % of the coal-based pitch binder were simply mechanically mixed, the temperature was raised to 600° C. at a rate of 3° C./min under a high-purity argon atmosphere, and the heat treatment was performed at 600° C. for 4 hours.

### Comparative Example 5

The process was performed in the same manner as in Example 1, except that in Step 3, 30 wt % of the silicon oxide prepared above (D50: 6.7 μm) and 70 wt % of scaly natural graphite primary particles (D50: 12.5 μm) were simply mechanically mixed, the temperature was raised to 600° C. at a rate of 3° C./min under a high-purity argon atmosphere, and the heat treatment was performed at 600° C. for 4 hours.

(Evaluation Method)

* Measurement of pH of Negative Electrode Slurry Including Core-Shell Composite

The pH of the slurries prepared in Comparative Examples 2 to 5 was measured, and the results are shown in the following Table 2.

* Evaluation of Interfacial Resistance

For the half batteries manufactured in Comparative Examples 2 to 5, the interfacial resistance values of the negative electrode were measured in the same manner as in Evaluation Example 1, and the results are shown in the following Table 2.

TABLE 2

| | | Time of | Time of | Heat treatment | | Interfacial |
|---|---|---|---|---|---|---|
| | | introducing | introducing | temperature | pH of | resistance |
| | Process | graphite | pitch | (° C.) | slurry | (Ohmcm²) |
| Comparative | Mechanochemical | Initially | Initially | 600 | 9.6 | 0.023 |
| Example 2 | | | | | | |
| Comparative | Mechanochemical | Initially | Not used | 600 | 10.4 | 0.024 |
| Example 3 | | | | | | |
| Comparative | Ball mill | Initially | Initially | 600 | 10.4 | 0.026 |
| Example 4 | | | | | | |
| Comparative | Ball mill | Initially | Not used | 600 | 11.2 | 0.032 |
| Example 5 | | | | | | |

As seen in Table 2, in Comparative Examples 4 and 5 in which simple mechanical mixing was performed by a ball mill without performing the mechanochemical treatment, and then the heat treatment was performed, a high pH of slurry was shown as compared with Comparative Examples 2 and 3 having the same time point of introducing the coal-based pitch binder. It is considered that since the compounding of the silicon oxide and the natural graphite particles was not sufficiently performed by a ball mill and the materials were stayed in a simple mixed state, the silicon oxide was directly exposed to the outside, not to the inside of the core, and thus, a large amount of the lithium compound was eluted during the process of preparing the slurry to increase the pH of the slurry.

In addition, in Comparative Examples 3 and 5 in which the coal-based pitch binder was not used, it is considered that since there was no effect of preventing the elution of the lithium compound by the shell including the coal-based pitch binder, a high pH of the slurry was shown as compared with Comparative Examples 2 and 4, and in particular, in Comparative Example 5, since the compounding of the silicon oxide and the natural graphite particles was not sufficiently performed by simple mechanical mixing and the silicon oxide was directly exposed to the slurry, a high pH of the slurry was shown as compared with Comparative Example 3.

In addition, it was confirmed that both Comparative Examples 4 and 5 showed higher resistance values than Comparative Examples 2 and 3. It is considered that since the compounding of the silicon oxide and the natural graphite particles was weakly formed by simple mechanical mixing by a ball mill, the electron conductive path was not sufficient in the silicon oxide, so that a high resistance was shown. In particular, in Comparative Examples 3 and 5 in which the coal-based pitch binder was not used, since there was no electron conductive path formed by the penetration of the coal-based pitch binder into the core, a higher resistance was shown than Comparative Examples 2 and 4.

### Evaluation Example 3: Evaluation of Characteristics Depending on Heat Treatment Temperature

### Examples 1 and 3 to 7

### Examples 3 to 7

The process was performed in the same manner as in Example 1, except that in Step 3, the temperature of the heat treatment was those represented in the following Table 3, instead of 600° C.

(Evaluation Method)

* Raman Spectrum Analysis

Raman spectrum analysis was performed for the negative electrode active materials prepared according to Example 1 and 3 to 7, and specifically, an Invia confocal Raman microscope available from Renishaw (UK) was used, the surface of the particles was measured 8 times in a range of 67-1800 cm⁻¹ in a static mode at a laser wavelength of 532 nm at a lens magnification of 50 times, and the average value thereof was applied.

Meanwhile, in the analysis method of Raman spectrum, a region of 515±15 cm⁻¹ or more may be defined as a region of crystalline Si (c-Si), and a region less than that may be defined as a mixed region of amorphous Si (a-Si) derived from an amorphous silicon oxide (SiOₓ) and amorphous Si from a lithium silicate. The evaluation results are shown in the following Table 3.

* Analysis of Si Crystallite Size of Silicon Compound by X-Ray Diffraction Analysis Method

X-ray diffraction analysis was performed for the composites prepared according to Examples 1 and 3 to 7, and specifically, Empyrean XRD diffractometer available from Malvern Panalytical Ltd. was used and a current of 40 mA at a voltage of kV was applied for measurement. Specifically, a half-band width of a diffraction peak caused by a Si (111) crystal face (2θ=28.4±0.3°) was obtained by X-ray diffraction using a Cu-Kα ray. Scherrer's equation was used to analyze the size of Si crystallites, and the results are shown in the following Table 3:

Scherrer Equation: τ=(Kλ)/(β cos θ)

(K: dimensionless shape factor, 0.9,

λ: X-ray wavelength, 0.1540598 nm,

β: full width at half maximum,

θ: Bragg angle)

* Evaluation of Life Characteristics

The half batteries manufactured according to Examples 1 and 3 to 7 were charged at a constant current at a current of 0.1 C rate at room temperature (25° C.) until the voltage reached 0.01 V (vs. Li), and then were cut-off at a current of 0.01 C rate while maintaining 0.01 V in a constant voltage mode to be charged at a constant voltage. The battery was discharged at a constant current of 0.1 C rate until the voltage reached 1.5 V (vs. Li). The charge and discharge were set as one cycle, one more cycle of charge and discharge was identically performed, and then 50 cycles in which the applied current was changed to 0.5 C during charge and discharge were performed, with a pause of 10 minutes between the cycles. Life characteristics as a capacity retention rate (%) which is a discharge capacity for 50 cycles to a discharge capacity for one cycle were measured, and the results are shown in the following Table 3.

TABLE 3

| | | | | | | | | Capacity |
|---|---|---|---|---|---|---|---|---|
| | | | | Heat | | | Maximum peak | retention |
| | | Time of | Time of | treatment | | Size of Si | position in | rate after 50 |
| | | Introducing | introducing | temperature | pH of | crystallite | Raman spectrum | cycles |
| | Process | graphite | pitch | (° C.) | slurry | (nm) | (cm⁻¹) | (%) |
| Example 1 | Mechanochemical | Initially | After 30 | 600 | 8.7 | Unmeasured | 467 | 86.9 |
| | | | minutes | | | | | |
| Example 3 | Mechanochemical | Initially | After 30 | 500 | 8.5 | Unmeasured | 470 | 75.1 |
| | | | minutes | | | | | |
| Example 4 | Mechanochemical | Initially | After 30 | 700 | 8.6 | 2 | 471 | 84.3 |
| | | | minutes | | | | | |
| Example 5 | Mechanochemical | Initially | After 30 | 800 | 8.5 | 9 | 518 | 79.4 |
| | | | minutes | | | | | |
| Example 6 | Mechanochemical | Initially | After 30 | 900 | 8.5 | 20 | 520 | 75.2 |
| | | | minutes | | | | | |
| Example 7 | Mechanochemical | Initially | After 30 | 1000 | 8.6 | 27 | 521 | 72.8 |
| | | | minutes | | | | | |

As seen in Table 3, when the heat treatment temperature was 700° C. or lower, the maximum peak position in the Raman spectrum was shown at 461 to 471 cm⁻¹, and thus, it was confirmed that production of a Si crystal phase was insignificant. However, when the heat treatment temperature was 800 to 1000° C., the maximum peak position in the Raman spectrum was shown at 500 cm⁻¹ or more, and thus, it was confirmed that production of a Si crystal phase was promoted.

In addition, when the heat treatment temperature was 700° C. or lower, it was confirmed that the non-crystalline characteristics of Si in the silicon oxide were maintained well, and when the heat treatment temperature was higher than 700° C., it was confirmed that the size of the produced Si crystallite was increased with the increase in temperature.

In Example 1 having the heat treatment temperature of 600° C., it is considered that the non-crystalline characteristics of Si in the silicon oxide were maintained well, the coal-based pitch binder was sufficiently carbonized, and the carbonized coal-based pitch binder was uniformly applied on the inside of the core and the shell of the core-shell composite, so that a low pH of the slurry and a high capacity retention rate were shown. It is considered that as the non-crystalline characteristics of Si are maintained well, volume expansion of the composite due to the growth of c-Si (crystalline Si) in the silicon oxide was suppressed to effectively suppress deterioration of the negative electrode active material, and also, the carbonized coal-based pitch binder served as a buffer to relieve volume expansion in the interface between the silicon oxide and the natural graphite particles inside the core, thereby suppressing a capacity decrease and suppressing elution of the lithium compound into the slurry by the uniformly formed shell to effectively suppress a pH increase.

In Example 3, it is considered that as the heat treatment temperature was lowered to 500° C., the coal-based pitch binder was not sufficiently carbonized to decrease the conductivity of the core-shell composite, and the capacity retention rate was low with a decrease in the electron conductive path during charge and discharge.

In Example 4, it is considered that as the heat treatment temperature was raised to 700° C., the coal-based pitch binder was sufficiently carbonized, and the conductivity of the core-shell composite was increased, so that a high capacity retention rate was shown. However, it is considered that as the heat treatment temperature was raised, crystallization of a Si phase in the silicon oxide was caused to deteriorate structural stability of the negative electrode active material including the silicon oxide, and thus, the capacity retention rate was lower than Example 1.

In Examples 5 to 7, it is considered that the heat treatment temperature was raised to 800, 900, and 1000° C., respectively, and crystallization of the Si phase described above occurred more severe, and thus, the capacity retention rate depending on the composite volume expansion was lowered as the temperature was raised.

### Evaluation Example 4: Measurement of Lithium Content and Lithium Silicate Content in Core-Shell Composite

### Examples 1 and 8 to 10, and Comparative Example 2

### Examples 8 to 10

The process was performed in the same manner as in Example 1, except that in Step 2, the mole ratio of Li/Si and the wt % of the coal-based pitch binder were those shown in the following Table 4.

(Evaluation Method)

* Inductively Coupled Plasma Spectrometer (ICP) Analysis of Core-Shell Composite

The half batteries manufactured in Examples 1 and 8 to 10, and Comparative Example 2 were disassembled, washed, and dried, ICP analysis of the core-shell composite was performed, and a lithium content (wt %) is shown in the following Table 4.

* Measurement of Lithium Silicate Content

X-ray diffraction (XRD) analysis of the core-shell composites prepared in Examples 1 and 8 to 10, and Comparative Example 2 was performed. For XRD analysis, Empyrean XRD diffractometer available from Malvern Panalytical Ltd. was used, and measurement was performed by applying a current of 40 mA at a voltage of 45 kV. Analysis of each phase was performed by comparison with JCPDS card No. 98-002-9287 (Si), 98-002-8192 (Li₂SiO₃), 98-028-0481 (Li₂Si₂O₅), and 98-003-5169 (Li₄SiO₄). From the thus-obtained results, peaks of Li₄SiO₄(110) positioned at 22.2±0.3°, Li₂Si₂O₅(111) positioned at 24.9±0.3°, and Li₂SiO₃(111) positioned at 26.9±0.3° were confirmed.

For each lithium silicate, an area of each peak was calculated by a Rietveld method and subjected to quantitative analysis. The results are summarized in the following Table 4.

TABLE 4

| | Prelithiation | Coal-based | Compounding | | Lithium | | Amorphous |
|---|---|---|---|---|---|---|---|
| | conditions | pitch binder | process time | Lithium | silicate | | carbon |
| | Li/Si mole | content | of introducing | content | content | | content |
| | ratio | (wt %) | pitch | (A, wt %) | (B, wt %) | A/B | (C, wt %) |
| Example 1 | 0.75 | 10 | After 30 | 3.0 | 73 | 0.041 | 8 |
| | | | minutes | | | | |
| Example 8 | 0.33 | 10 | After 30 | 1.5 | 36 | 0.042 | 8 |
| | | | minutes | | | | |
| Example 9 | 1.00 | 10 | After 30 | 3.4 | 79 | 0.043 | 8 |
| | | | minutes | | | | |
| Example 10 | 0.75 | 6 | After 30 | 2.5 | 75 | 0.033 | 5 |
| | | | minutes | | | | |
| Example 11 | 0.75 | 18 | After 30 | 3.0 | 74 | 0.041 | 15 |
| | | | minutes | | | | |
| Comparative | 0.75 | 10 | Initially | 2.4 | 75 | 0.032 | 8 |
| Example 2 | | | | | | | |
| Comparative | 0.75 | — | Not used | 1.2 | 76 | 0.016 | — |
| Example 3 | | | | | | | |

(In Table 4, the lithium content is a wt % to the total weight of the core-shell composite, and the lithium silicate content is a wt % to the total weight of the silicon oxide in the core-shell composite.)

As seen in Table 4, it was confirmed that the lithium content (A) in the core-shell composite, when being prelithiated, tended to be proportional to the Li/Si mole ratio, under the same core-shell composite condition (Examples 1, 8, and 9). In Example 9, it was shown that though the Li/Si mole ratio was increased by 33% as compared with Example 1, the lithium silicate content (B) included in the core-shell composite was not much increased. It is considered that when the Li/Si mole ratio was 1, a Li₄SiO₄ phase was formed much as compared with Li₂SiO₃ or Li₂Si₂O₅, so that the lithium silicate content was decreased.

In addition, in Example 10, since the content of the coal-based pitch binder was decreased in the preparation of the core-shell composite, the lithium content in the composite was low, though the Li/Si mole ratio was the same as in Example 1. It is considered that the amorphous carbon content in the produced composite was decreased and the effect of suppressing elution of the lithium compound by the shell was decreased.

In Example 11, the content of the coal-based pitch binder was increased in the preparation of the core-shell composite, but the lithium content was similar to Example 1 having the same Li/Si mole ratio. It is considered that when the content of the amorphous carbon included in the composite shell was more than a certain content (8 wt %), the effect of suppressing elution of the lithium compound was not increased any more.

In Comparative Examples 2 and 3, since the coal-based pitch binder was introduced at the beginning of the process or the coal-based pitch binder was not used, elution of the lithium compound occurred much, and thus, the lithium content was low even with the same Li/Si mole ratio as Example 1. In particular, in Comparative Example 3, it is considered that since the coal-based pitch binder was not included, the shell was not formed and a very low lithium content in the composite was shown.

Meanwhile, from the results of Example 1, 8, and 9, it is seen that a preferred range of the lithium content in the composite is 1.3 wt % or more, preferably 1.3 to 5 wt %, and more preferably 1.3 to 4 wt %.

The negative electrode active material for a lithium secondary battery according to the present invention may solve problems of initial efficiency and capacity deterioration.

In addition, expansion of silicon-based oxide particles due to a charge and discharge process may be suppressed to improve electrode stability and life characteristics.

In addition, elution of a lithium compound remaining on a surface of prelithiated silicon-based oxide particles may be prevented to improve stability of a slurry and battery life characteristics.

Although the exemplary embodiments of the present invention have been described above, the present invention is not limited to the exemplary embodiments but may be made in various forms different from each other, and those skilled in the art will understand that the present invention may be implemented in other specific forms without departing from the spirit or essential feature of the present invention. Therefore, it should be understood that the exemplary embodiments described above are not restrictive, but illustrative in all aspects.

What is claimed is:

1. A negative electrode active material for a lithium secondary battery, the negative electrode active material comprising a core-shell composite comprising:
a core comprising a silicon oxide (SiOₓ, 0<x≤2) containing a lithium compound and a graphitic material; and
a shell comprising amorphous carbon, positioned on the core,
wherein the silicon oxide (SiOₓ, 0<x≤2) comprises at least one lithium silicate selected from Li₂SiO₃, Li₂Si₂O₅, and Li₄SiO₄ in at least a part of the silicon oxide.

2. The negative electrode active material of claim 1, wherein the lithium compound is at least one or more selected from LiOH, Li, LiH, Li₂O, and Li₂CO₃.

3. The negative electrode active material of claim 1, wherein the silicon oxide containing a lithium compound has a maximum peak position at 460 cm⁻¹ to 500 cm⁻¹ in a Raman spectrum.

4. The negative electrode active material of claim 1, wherein the silicon oxide containing a lithium compound has a maximum peak position at 500 cm⁻¹ to 530 cm⁻¹ in a Raman spectrum.

5. The negative electrode active material of claim 1, wherein the core further comprises amorphous carbon.

6. The negative electrode active material of claim 1, wherein the graphitic material is natural graphite, artificial graphite, or a combination thereof.

7. The negative electrode active material of claim 1, wherein the silicon oxide is comprised at 5 to 50 parts by weight, with respect to 100 parts by weight of the core-shell composite.

8. The negative electrode active material of claim 1, wherein the graphitic material is comprised at 30 to 80 parts by weight, with respect to 100 parts by weight of the core-shell composite.

9. The negative electrode active material of claim 1, wherein the shell has an average thickness of 0.1 to 100 nm.

10. The negative electrode active material of claim 1, wherein the composite is comprised at 50 parts by weight or more, with respect to 100 parts by weight of the negative electrode active material.

11. A method of preparing a negative electrode active material for a lithium secondary battery, the method comprising:
step a) preparing a silicon oxide (SiOₓ, 0<x≤2) containing a lithium compound;
step b) compounding the silicon oxide containing a lithium compound, a graphitic material, and a carbon precursor to prepare a core-shell composite precursor; and
step c) heat-treating the core-shell composite precursor to prepare a core-shell composite,
wherein the compounding in step b) comprises dry mixing with a shear stress and a centrifugal force applied, and the carbon precursor is introduced in the middle of the dry mixing, and
the silicon oxide (SiOₓ, 0<x≤2) comprises at least one lithium silicate selected from Li₂SiO₃, Li₂Si₂O₅, and Li₄SiO₄ in at least a part of the silicon oxide particles.

12. The method of preparing a negative electrode active material of claim 11, wherein the compounding in step b) is performed by a mechanochemical treatment.

13. The method of preparing a negative electrode active material of claim 11, wherein step c) is performed under an inert atmosphere.

14. The method of preparing a negative electrode active material of claim 11, wherein step a) is mixing and heat-treating a silicon compound and a lithium precursor.

15. The method of preparing a negative electrode active material of claim 11, wherein the lithium compound is at least one or more selected from LiOH, Li, LiH, Li₂O, and Li₂CO₃.

16. A lithium secondary battery comprising the negative electrode active material according to claim 1.
